(19) United States
(12) Patent Application Publication
(10) Pub. No.: US 2013/0156923 A1
(43) Pub. Date: Jun. 20, 2013

(54) SOLID COMPOSITION

(71) Applicant: Kao Corporation, Chuo-ku (JP)

(72) Inventors: Aiko SHUDO, Ichikawa-shi (JP); Nobuteru Ishizuka, Funabashi-shi (JP)

(73) Assignee: Kao Corporaiton, Chuo-ku (JP)

(21) Appl. No.: 13/714,816

(22) Filed: Dec. 14, 2012

(30) Foreign Application Priority Data
Dec. 15, 2011 (JP) 2011-274580

(51) Int. Cl. A23L 1/305

(52) U.S. Cl. CPC A23L 1/3055
USPC 426/548

(57) ABSTRACT

Provided is a masticatory solid composition including the following components (A) and (B):
(A) wheat albumin, and
(B) erythritol, xylitol, or a combination thereof,
   wherein
   a content mass ratio of the component (B) to the component (A) [(B)/(A)] is 0.25 or more.

### FIELD OF THE INVENTION

The present invention relates to a masticatory solid composition containing wheat albumin.

Priority is claimed on Japanese Patent Application No. 2011-274580 filed Dec. 15, 2011 and Japanese Patent Application No. 2012-253952 filed Nov. 20, 2012, the content of which is incorporated herein by reference.

### BACKGROUND OF THE INVENTION

Recently, the number of patients suffering from glucose metabolic disorders represented by obesity and type II diabetes mellitus (hyperglycemia) has been increasing due to, for example, changes in diet and the like.

In general, after eating, in particular, after ingestion of diet containing carbohydrates, the blood glucose level is increased, and thereby insulin is secreted by β-cells of the pancreas. Insulin acts on muscle, liver, adipose tissue, etc. and the intake of sugar into cells is promoted, to thereby suppress an acute increase in blood glucose level after eating. If a high blood glucose level after eating continues because of a decrease in insulin sensitivity (insulin resistance), the pancreas secretes a large amount of insulin for suppressing the increase in blood glucose level. Furthermore, if such a condition continues for a long time, the pancreas is exhausted, the secretion of insulin from the pancreatic β-cells is decreased, and, ultimately, the mechanism of action of insulin does not normally function, which causes, for example, type II diabetes mellitus.

The postprandial hyperglycemia symptoms associated with insulin resistance are observed also in healthy individuals not suffering from diabetes mellitus and individuals suffering from borderline diabetes mellitus. The postprandial hyperglycemia symptoms are also known to cause or be exacerbating factors of, for example, obesity, hyperlipidemia, and arteriosclerosis, in addition to type II diabetes mellitus. Accordingly, from the viewpoints of health maintenance and decreasing onset risks and prevention of these symptoms and diseases, it is very important to prevent the postprandial hyperglycemia symptoms.

Accordingly, many materials that can suppress an acute increase in blood glucose level and secretion of insulin after eating have been developed in recent years. One example of such materials is amylase inhibitors, and an amylase inhibitor derived from wheat is used in prevention or therapy for, for example, diabetes mellitus and obesity (Non Patent Document 1).

The endosperm of wheat contains about 10 to 150 of protein. It has been reported that albumin (water-soluble protein) occupying about 11% of the protein composition has an α-amylase inhibiting activity and physiological functions such as an action of suppressing a postprandial increase in blood glucose level and an action of improving insulin resistance (Non Patent Documents 1 and 2). In particular, wheat albumin having an electrophoretic mobility of 0.19 has a high α-amylase inhibiting activity and is therefore expected to be applied to a variety of foods.

It is believed that in order to express the physiological functions of the wheat albumin, ingestion of 125 mg or more of wheat albumin having an electrophoretic mobility of 0.19 (hereinafter, also may be referred to as 0.19-wheat albumin) all at once in each meal is effective (Non Patent Document 2). As health foods having effective amounts of wheat albumin blended therein, soups and hard capsules have been marketed. In addition, Patent Document 1 discloses tablets having 0.19-wheat albumin blended therein.

### PRIOR ART REFERENCE

### Patent Document

[Patent Document 1] JP-A-2010-173962

### Non Patent Document

[Non Patent Document 1] Yakuri to Chiryo (Pharmacology and Therapeutics), 2008, Vol. 36, No. 8, pp. 761-765.

[Non Patent Document 2] European Journal of Clinical Nutrition, 2005, Vol. 59, pp. 384-392.

### SUMMARY OF THE INVENTION

The present invention provides a masticatory solid composition containing the following components (A) and (B):
(A) wheat albumin, and
(B) erythritol, xylitol, or a combination thereof,
   wherein
   the content mass ratio of component (B) to component (A) [(B)/(A)] is 0.25 or more.

### DETAILED DESCRIPTION OF THE INVENTION

In order to ingest wheat albumin effortlessly and continuously for a long term, a masticatory solid composition in a form of allowing easy ingestion in a small amount at a time is advantageous.

The investigation by the present inventors, however, revealed that it is difficult to blend wheat albumin in a solid composition in high concentration such that an effective amount of wheat albumin can be ingested by only ingesting a small amount of the composition once. That is, it was revealed that an increase in the concentration of wheat albumin causes bad gnawing and heavy texture to make eating difficult.

Accordingly, the present invention provides a masticatory solid composition having good texture, while containing a high concentration of wheat albumin. Note that Patent Document 1 mentioned above does not describe at all about improvement of texture of tablets containing wheat albumin.

The present inventors diligently studied to solve the above-mentioned problems and, as a result, found that a masticatory solid composition containing a high concentration of wheat albumin can give good gnawing feeling and light texture by containing erythritol or xylitol.

The present invention can provide a masticatory solid composition, which give good gnawing feeling and light texture by improving the uncomfortable texture of wheat albumin, though the composition contains a high concentration of wheat albumin.

The masticatory solid composition of the present invention allows ingestion of wheat albumin in an amount sufficient for expressing the physiological effect thereof by only ingesting a small amount of the composition once. Accordingly, the effect of the wheat albumin can be expected over a long time.

The wheat albumin (A) used in the present invention is a water-soluble protein belonging to an albumin family derived from the endosperm of wheat. In light of having a high a-amylase inhibiting activity, it is preferable that the wheat albumin includes wheat albumin having an electrophoretic mobility of 0.19. Incidentally, herein, the term “electrophoretic mobility” refers to the mobility of a sample in electrophoresis on polyacrylamide gel in accordance with the method of Davis (Annals of the New York Academy of Science, 121, 404-427, 1964).

The wheat albumin mentioned above can be extracted from the endosperm of wheat. The wheat albumin can be extracted from wheat by, for example, the method of preparing an amylase inhibitor described in JP-A-9-172999.

In addition, commercially available products such as wheat albumin NA-1 (Nisshin Pharma Inc.) may be used.

The content of the wheat albumin (A) in the masticatory solid composition of the present invention is 10% by mass (hereinafter, simply referred to as “%”) or more, preferably 20% or more, more preferably 25% or more, and even more preferably 30% or more from the viewpoints of intake for effectively expressing the physiological effect and of form which allows ingestion in a small amount at a time, and 70% or less, preferably 65% or less, more preferably 60% or less, and even more preferably 50% or less from the viewpoint of expressing good texture. Specifically, the content is 10 to 70%, preferably 20 to 70%, more preferably 25 to 65%, even more preferably 25 to 60%, even more preferably 25 to 50%, and even more preferably 30 to 50%.

The content of 0.19-wheat albumin (a) in the wheat albumin (A) is 10% or more, preferably 15% or more, more preferably 20% or more, and even more preferably 25% or more from the viewpoint of intake for effectively expressing the physiological effect and is 60% or less, preferably 40% or less, more preferably 35% or less, and even more preferably 31% or less from the viewpoint of ease of manufacturing of wheat albumin. Specifically, the content is 10 to 60%, preferably 15 to 40%, more preferably 20 to 35%, and even more preferably 25 to 31%.

The content of 0.19-wheat albumin (a) in the masticatory solid composition of the present invention is 2.5% or more, preferably 3.5% or more, and more preferably 6% or more from the viewpoint of intake for effectively expressing the physiological effect and is 20% or less, more preferably 14.5% or less, and even more preferably 13% or less from the viewpoint of expressing good texture. Specifically, the content is 2.5 to 20%, preferably 3.5 to 14.5%, and more preferably 6 to 13%.

The content of 0.19-wheat albumin in the masticatory solid composition of the present invention can be measured by HPLC. For example, the method of measuring the content of 0.19-amylase inhibitor described in JP-A-9-172999 can be employed.

The masticatory solid composition of the present invention may contain erythritol or xylitol alone or a combination thereof. Hereinafter, “erythritol, xylitol, or a combination thereof” is also simply referred to as component (B).

The erythritol and xylitol may be those usually available and may be each an anhydride or a hydrate. In particular, erythritol is preferred from the viewpoint of better gnawing feeling.

Component (B) preferably has a particle size of 45 μm or more and less than 500 μm, more preferably 45 μm or more and less than 355 μm, and even more preferably 53 μm or more and less than 355 μm, from the viewpoints of expressing a shape-retaining property and good texture.

The particle size of component (B) is the value of that obtained by sorting particles with the following sieve.
Sieve: JIS standard sieve, φ: 75 mm,
Opening: there is a receiver under a sieve having openings of 500 μm, 355 μm, 180 μm, 53 μm, and 45 μm respectively, in order from the upper stage.

Specifically, the content of component (B) having the particle size mentioned above in the total of component (B) is preferably 70% or more, more preferably 80% or more and even more preferably 90% or more.

The content of component (B) in the masticatory solid composition of the present invention is 15% or more, preferably 18% or more, more preferably 30% or more, and even more preferably 35% or more from the viewpoint of expressing good texture and is 90% or less, preferably 80% or less, more preferably 70% or less, even more preferably 65% or less, even more preferably 50% or less, and even more preferably 40% or less from the viewpoint of containing wheat albumin for effectively expressing the physiological effect. Specifically, the content is 15 to 90%, preferably 18 to 80%, more preferably 30 to 70%, and even more preferably 35 to 65%.

The content of component (B) can be measured by HPLC. For example, analysis by differential refractometry using an amino column is available (Shokumotsu Seni, Kiso to Oyo (Dietary Fiber, its Basis and Application), supervised by Japanese Association for Dietary Fiber Research, edited by Japanese Association for Dietary Fiber Research Editorial Committee, et al., written by Seiichiro Aoki, published by Dai-ichi Shuppan, Co., Ltd., in October 2008).

In the masticatory solid composition of the present invention, it is important that the content mass ratio of the erythritol, xylitol, or a combination thereof (B) to the wheat albumin (A) [(B)/(A)] is 0.25 or more. Uncomfortable texture derived from wheat albumin can be improved by adjusting the proportion of component (B) to be 0.25 or more based on 1 of the wheat albumin (A).

The content mass ratio of component (B) to component (A) [(B)/(A)] is 0.25 or more, preferably 0.5 or more, and more preferably 0.7 or more from the same viewpoints above, and 9 or less, preferably 4 or less, and more preferably 3 or less from the viewpoint of containing wheat albumin for effectively expressing the physiological effect. Specifically, the ratio is 0.25 to 9, preferably 0.5 to 4, and even more preferably 0.7 to 3.

Furthermore, in the masticatory solid composition of the present invention, the content mass ratio of the erythritol, xylitol, or a combination thereof (B) to the 0.19-wheat albumin (a) [(B)/(a)] is preferably 1 or more. Uncomfortable texture derived from wheat albumin can be improved by adjusting the proportion of component (B) to be 1 or more based on 1 of the 0.19-wheat albumin (a).

The content mass ratio of component (B) to component (a) [(B)/(a)] is 1 or more, preferably 2 or more, and more preferably 2.8 or more from the same viewpoints above and is 35 or less, preferably 15 or less, and more preferably 11 or less from the viewpoint of containing wheat albumin for effectively expressing the physiological effect. Specifically, the ratio is 1 to 35, preferably 2 to 15, and more preferably 2.8 to 11.

The masticatory solid composition of the present invention preferably further contains a carbonate (C) and an organic acid (D). The wheat albumin is combined with carbonate and the organic acid to generate carbon dioxide gas. In spite of the high concentration of wheat albumin, the generation of carbon dioxide gas suppresses stickiness and adhesion in the mouth and reduces the unusual taste characteristic to wheat albumin to provide a masticatory solid composition having good texture, taste and flavor.

Examples of the carbonate (C) used in the present invention include sodium carbonate, sodium hydrogen carbonate, potassium carbonate, potassium hydrogen carbonate, calcium carbonate, magnesium carbonate, and sodium sesquicarbonate. These carbonates may be used alone or in combination of two or more thereof.

The content of the carbonate (C) in the solid composition of the present invention is 2% or more, preferably 3% or more, and more preferably 10% or more from the viewpoint of physical properties and is 20% or less, preferably 19.5% or less, and more preferably 14% or less from the viewpoint of taste and flavor. Specifically, the content is 2 to 20%, preferably 3 to 19.5%, and more preferably 10 to 14%.

The organic acid (D) used in the present invention is edible acids, and examples thereof include organic acid such as citric acid, phosphoric acid, succinic acid, ascorbic acid, acetic acid, gluconic acid, malic acid, tartaric acid, fumaric acid, and adipic acid. These organic acids may be used alone or in combination of two or more thereof. In particular, citric acid and malic acid are preferred, with citric acid being more preferred from the viewpoints that stickiness and adhesion in the mouth during eating are less and generated bubbles have good texture.

The content of the organic acid (D) in the solid composition of the present invention is 2% or more, preferably 2.5% or more, more preferably 3% or more, and even more preferably 8% or more from the viewpoint of physical properties and is 18% or less, preferably 15% or less, more preferably 12% or less, and even more preferably 11% or less from the viewpoints of taste and flavor. Specifically, the content is 2 to 18%, preferably 2.5 to 15%, more preferably 3 to 12%, and even more preferably 8 to 11%.

In the solid composition of the present invention, the content mass ratio of the wheat albumin (A) to the carbonate (C) [(A)/(C)] is 1.5 or more, preferably 2.5 or more, more preferably 2.6 or more, and even more preferably 3.5 or more from the viewpoints of suppressing stickiness and adhesion in the mouth during eating and reducing the unusual taste characteristic to wheat albumin and is 16.5 or less, preferably 15.5 or less, more preferably 12 or less, and even more preferably 5 or less from the viewpoint of taste and flavor. Specifically, the ratio is 1.5 to 16.5, preferably 2.5 to 15.5, more preferably 2.6 to 12, and even more preferably 3.5 to 5.

The content mass ratio of the 0.19-wheat albumin (a) to the carbonate (C) [(a)/(C)] is 0.2 or more, preferably 0.3 or more, and more preferably 0.35 or more and is 4.1 or less, preferably 3.8 or less, and more preferably 3 or less, from the viewpoints of suppressing stickiness and adhesion in the mouth during eating and reducing the unusual taste characteristic to wheat albumin. Specifically, the ratio is 0.2 to 4.1, preferably 0.3 to 3.8, and more preferably 0.35 to 3.

Furthermore, in the solid composition of the present invention, the equivalent ratio of the organic acid (D) to the carbonate (C) [equivalent of (D)/equivalent of (C)] is 0.7 or more, preferably 0.8 or more, more preferably 0.85 or more, and even more preferably 0.9 or more and is 1.9 or less, preferably 1.8 or less, more preferably 1.2 or less, and even more preferably 1.1 or less, from the viewpoint of providing good balance in taste and flavor without prominent harshness derived from the carbonate and acid taste of the organic acid. Specifically, the ratio is 0.8 to 1.8, preferably 0.85 to 1.2, and more preferably 0.9 to 1.1.

In the present invention, the term “equivalent ratio” refers to the value obtained by dividing the equivalent of the organic acid (D) by the equivalent of the carbonate (C) in the solid composition.

In addition to the above-described components, the masticatory solid composition of the present invention may appropriately contained therein a mineral such as calcium, magnesium, iron, zinc, chromium, selenium, manganese, molybdenum, copper, iodine, phosphorus, potassium, and sodium; a vitamin such as vitamin A, vitamin B1, vitamin B2, vitamin B6, vitamin B12, vitamin C, vitamin E, and folic acid, and salts or esters thereof; a sweetener including a monosaccharide such as fructose, glucose, galactose, xylose, and tagatose, an oligosaccharide such as sucrose, lactose, maltose, trehalose, isomaltooligosaccharide, galactooligosaccharide, fructooligosaccharide, lactosucrose, soy oligosaccharide, isomaltulose, and coupling sugar, a sugar alcohol other than erythritol and xylitol, and a synthetic sweetener such as saccharin, sucralose, and acesulfame potassium; a flavor, a coloring agent, a preservative, or other additives, to the extent that the effects of the present invention is not impaired.

The masticatory solid composition of the present invention is ingested through mastication. The form thereof is not particularly limited as long as it is a solid, for example, at room temperature (15 to 25° C.) Examples of the form include capsules, tablets, and pills. In particular, tablets are preferred from the viewpoint of capable of ingesting a small amount of the composition at a time, and chewable tablets are more preferred from the viewpoint of ease of ingestion.

The masticatory solid composition of the present invention containing a carbonate (C) and an organic acid (D) generates carbon dioxide gas in the mouth or in the presence of water.

In order to prepare the composition in such a dosage form, according to need, an appropriate combination of additives can be used. The additives are, for example, an excipient such as lactose, starches, crystalline cellulose, sucrose, mannitol, light anhydrous silicic acid, and calcium hydrogen phosphate; a binder such as hydroxypropyl methylcellulose, hydroxypropylcellulose, gelatin, pregelatinized starch, polyvinyl pyrrolidone, polyvinyl alcohol, pullulan, methyl cellulose, and hydrogenated oil; a disintegrator such as carmellose, carmellose calcium, croscarmellose sodium, crospovidone, corn starch, and low substituted hydroxypropylcellulose; a lubricant such as calcium stearate, magnesium stearate, sodium stearyl fumarate, talc, and silicon dioxide; a corrigent such as stevia and aspartame; a flavor; a bulking filler; a surfactant; a dispersing agent; a buffer; a preservative; a coating; and carriers such as diluents.

The masticatory solid composition of the present invention can be produced by a common method without particular limitation. For example, the composition can be produced by preparing a mixture of the wheat albumin (A), the erythritol, xylitol, or a combination thereof (B), and optional additives, and subsequently subjecting the mixture to compression molding.

For example, in production of a tablet, the tablet may be molded by directly compressing the mixture (direct powder compression method) or may be molded by compression after granulation by, for example, dry granulation method or wet granulation method (granule compression method). In particular, from the viewpoint of ease of the process, the tablet is preferably molded by direct powder compression method.

In production of a tablet by direct compression, a tableting machine that is commonly used, such as a rotary tableting machine or a single punch tableting machine, can be used.

In production of a tablet from granules, the granules are produced by, for example, extruding granulation method using a basket granulator, a spheronization machine, a pelleter, etc.; crushing granulation using a speed mill, a power mill, etc.; rolling granulation; agitating granulation; or fluidized bed granulation, and the granules are dried and regulated in size. The resulting granules are compressed into a tablet with the above-mentioned tableting machine. The granules are regulated so as to preferably have a particle diameter of 45 to 850 μm, more preferably 100 to 500 μm.

The tablet may be a round tablet or an odd-shaped tablet having, for example, elliptic, oval, or square faces.

In addition, the compression molding pressure during tableting is about 100 to 3000 kg/cm² from the viewpoints of maintaining the hardness, the disintegration, etc. of molded products.

Furthermore, the weight of each tablet of the present invention is preferably 0.1 to 2 g, more preferably 1 to 2 g from the viewpoints of ease and effectiveness.

Regarding the above-described embodiment, the present invention further discloses the following compositions.
[1] A masticatory solid composition containing the following components (A) and (B):
(A) wheat albumin, and
(B) erythritol, xylitol, or a combination thereof,
   wherein
   the content mass ratio of component (B) to component (A) [(B)/(A)] is 0.25 or more.
[2] The masticatory solid composition according to aspect [1], wherein the content of the wheat albumin (A) in the masticatory solid composition is 10% by mass or more, preferably 20% by mass or more, more preferably 25% by mass or more, and even more preferably 30% by mass or more, and 70% by mass or less, preferably 65% by mass or less, more preferably 60% by mass or less, and even more preferably 50% by mass or less.
[3] The masticatory solid composition according to aspect [1] or [2], wherein the content mass ratio of the erythritol, xylitol, or a combination thereof (B) to the wheat albumin (A) [(B)/(A)] is 0.25 or more, preferably 0.5 or more, and even more preferably 0.7 or more, and 9 or less, preferably 4 or less, and even more preferably 3 or less.
[4] The masticatory solid composition according to any one of aspects [1] to [3], wherein the wheat albumin (A) contains 0.19-wheat albumin (a) and the content of 0.19-wheat albumin (a) in the wheat albumin (A) is 10% by mass or more, preferably 15% by mass or more, more preferably 20% by mass or more, and even more preferably 25% by mass or more, and 60% by mass or less, preferably 40% by mass or less, more preferably 35% by mass or less, and even more preferably 31% by mass or less.
[5] A masticatory solid composition containing the following components (a) and (B):
(a) 0.19-wheat albumin, and
(B) erythritol, xylitol, or a combination thereof,
   wherein
   the content mass ratio of component (B) to component (a) [(B)/(a)] is 1 or more.
[6] The masticatory solid composition according to aspect [5], wherein the content mass ratio of the erythritol, xylitol, or a combination thereof (B) to the 0.19-wheat albumin (a) [(B)/(a)] is 1 or more, preferably 2 or more, more preferably 2.8 or more, and 35 or less, preferably 15 or less, and more preferably 11 or less.
[7] The masticatory solid composition according to any one of aspects [1] to [6], wherein the content of the 0.19-wheat albumin (a) in the masticatory solid composition is 2.5% by mass or more, more preferably 3.5% by mass or more, and even more preferably 6% by mass or more, and 20% by mass or less, more preferably 14.5% by mass or less, and even more preferably 13% by mass or less.
[8] The masticatory solid composition according to any one of aspects [1] to [7], wherein the erythritol, xylitol, or a combination thereof (B) is preferably erythritol.
[9] The masticatory solid composition according to any one of aspects [1] to [8], wherein the content of the erythritol, xylitol, or a combination thereof (B) in the masticatory solid composition is 15% by mass or more, preferably 18% by mass or more, more preferably 30% by mass or more, and even more preferably 35% by mass or more, and 90% by mass or less, preferably 80% by mass or less, more preferably 70% by mass or less, even more preferably 65% by mass or less, even more preferably 50% by mass or less, and even more preferably 40% by mass or less.
[10] The masticatory solid composition according to any one of aspects [1] to [9], further containing a carbonate (C) and an organic acid (D).
[11] The masticatory solid composition according to aspect [10], wherein the carbonate (C) is at least one selected from the group consisting of sodium carbonate, sodium hydrogen carbonate, potassium carbonate, potassium hydrogen carbonate, calcium carbonate, magnesium carbonate, and sodium sesquicarbonate.
[12] The masticatory solid composition according to aspect [10] or [11], wherein the organic acid (D) is at least one selected from the group consisting of citric acid, phosphoric acid, succinic acid, ascorbic acid, acetic acid, gluconic acid, malic acid, tartaric acid, fumaric acid, and adipic acid, preferably citric acid, malic acid, or a combination thereof, and more preferably citric acid.
[13] The masticatory solid composition according to any one of aspects [10] to [12], wherein the content of the carbonate (C) in the solid composition is 2% by mass or more, preferably 3% by mass or more, and more preferably 10% by mass or more, and 20% by mass or less, preferably 19.5% by mass or less, and more preferably 14% by mass or less.
[14] The masticatory solid composition according to any one of aspects [10] to [13], wherein the content of the organic acid (D) in the masticatory solid composition is 2% by mass or more, preferably 2.5% by mass or more, more preferably 3% by mass or more, and even more preferably 8% by mass or more, and 18% by mass or less, preferably 15% by mass or less, more preferably 12% by mass or less, and even more 11% by mass or less.
[15] The masticatory solid composition according to any one of aspects [10] to [14], wherein the content mass ratio of the wheat albumin (A) to the carbonate (C) [(A)/(C)] in the masticatory solid composition is 1.5 or more, preferably 2.5 or more, more preferably 2.6 or more, and even more preferably 3.5 or more, and 16.5 or less, preferably 15.5 or less, more preferably 12 or less, and even more preferably 5 or less.
[16] The masticatory solid composition according to any one of aspects [10] to [15], wherein the content mass ratio of the 0.19-wheat albumin (a) to the carbonate (C) [(a)/(C)] in the masticatory solid composition is 0.2 or more, preferably 0.3 or more, and more preferably 0.35 or more, and 4.1 or less, preferably 3.8 or less, and more preferably 3 or less.
[17] The masticatory solid composition according to any one of aspects [10] to [16], wherein the equivalent ratio of the organic acid (D) to the carbonate (C) [equivalent of (D)/equivalent of (C)] is 0.7 or more, preferably 0.8 or more, more preferably 0.85 or more, and even more preferably 0.9 or more, and 1.9 or less, preferably 1.8 or less, more preferably 1.2 or less, and even more preferably 1.1 or less.
[18] The masticatory solid composition according to any one of aspects [1] to [17], wherein the masticatory solid composition is a chewable tablet.

### EXAMPLES

### Raw Materials

Wheat albumin: wheat albumin NA-1, manufactured by Nisshin Pharma Inc. (0.19-wheat albumin content: 25%)

Erythritol: erythritol (B Food Science Co., Ltd.)

Xylitol: xylitol (B Food Science Co., Ltd.)

Erythritol and xylitol used for preparing chewable tablets were sorted with a sieve so that the particular sizes were regulated to 45 μm or more and less than 355 μm.

### Analysis of Carbonate

The carbonate content in a masticatory solid composition is analyzed as follows.

In a container, 0.1 to 0.2 g of a masticatory solid composition is weighed, and 10 mL of water and 2 mL of 50% phosphoric acid are added thereto. The container is sealed, and the mixture is sonicated for 10 minutes and is subsequently left to stand for 1 hour. The head-space gas is subjected to gas chromatography to determine the amount of CO₂, and the carbonate content is determined from the amount of CO₂ generated. Gas chromatography operating conditions

Model: GC-14B (Shimadzu Corporation)

Detector: TCD

Column: Chromosorb 101, 80 to 100 mesh, glass tube: φ3.2 mm×2 m

Temperature: column: 50° C., inlet and detector: 100° C.

Cell electric current: 75 mA

Gas pressure: helium (carrier gas): 100 kPa

Injection volume: head-space gas: 0.2 mL

### Analysis of Organic Acid

The organic acid content in a masticatory solid composition is analyzed as follows.

One gram of a masticatory solid composition is weighed, and 20 mL of 5% perchloric acid is added thereto. The resulting mixture is shaken for 10 minutes for extraction. The volume is adjusted to 200 mL with water, and sonication is performed for 10 minutes. After filtration, the resulting sample is subjected to high-performance liquid chromatography.

### High-Performance Liquid Chromatography Operating Conditions

Model: LC-20AD (Shimadzu Corporation)

Detector: ultraviolet and visible spectrophotometer SPD-20AV (Shimadzu Corporation)

Column temperature: 40° C.

Mobile phase: 3 mmol/L perchloric acid

Reaction solution: 15 mmol/L disodium hydrogen phosphate solution containing 0.2 mmol/L bromothymol blue

Flow rate: mobile phase: 1.0 mL/min, reaction solution: 1.4 mL/min

Measurement wavelength: 445 nm

### Preparation of Chewable Tablet

### Examples 1 to 10 and Comparative Examples 1 to 6

Raw material components were mixed based on the blending compositions shown in Table 1. Subsequently, each mixture was compressed into a tablet having a weight of 1000 mg using a single punch tableting machine (manufactured by Riken Seiki Co., Ltd.) with a ring-form punch having a hole diameter of 13 mm to obtain a chewable tablet. The content of 0.19-wheat albumin (a) in the chewable tablet is shown in Table 1.

The resulting inventive products and comparative products were subjected to sensory evaluation. The evaluation was performed by three specialized panelists for gnawing feeling during eating and light texture in accordance with the evaluation criteria shown below, and average values were used as marks. In the present invention, the term “gnawing feeling” refers to the feeing in masticating without licking, i.e., a good feeling in biting off, and the term “light texture” refers to chewing feeling in masticating. The results are shown in Table 1.

### Gnawing Feeling

4: gnawing feeling is very good

3: gnawing feeling is good

2: gnawing feeling is bad

1: gnawing feeling is very bad

### Light Texture

4: very light texture

3: light texture

2: not very light texture

1: not light texture

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Composition | (A) Wheat albumin | 25 | 50 | 56 | 50 | 60 | 69 | 20 | 40 |
| (% by mass) | (B) Erythritol | 63 | 38 | 32 | — | — | — | 68 | 20 |
| | (B) Xylitol | — | — | — | 38 | 28 | 19 | — | — |
| | Mannitol | — | — | — | — | — | — | — | — |
| | Glucose | — | — | — | — | — | — | — | — |
| | Lactose | — | — | — | — | — | — | — | 28 |
| | Crystalline cellulose | 10 | 10 | 10 | 10 | 10 | 10 | 10 | 10 |
| | Calcium stearate | 2 | 2 | 2 | 2 | 2 | 2 | 2 | 2 |
| | Total | 100.0 | 100.0 | 100.0 | 100.0 | 100.0 | 100.0 | 100.0 | 100.0 |
| (a) 0.19-wheat albumin (% by mass) | | 6.3 | 12.5 | 14.0 | 12.5 | 15.0 | 17.3 | 5.0 | 10.0 |
| (B)/(A) | | 2.52 | 0.76 | 0.57 | 0.76 | 0.47 | 0.28 | 3.40 | 0.50 |
| (B)/(a) | | 10.08 | 3.04 | 2.29 | 3.04 | 1.87 | 1.10 | 13.60 | 2.00 |
| Evaluation | Gnawing feeling | 4 | 4 | 4 | 3 | 3 | 3 | 4 | 4 |
| | Light texture | 4 | 4 | 3 | 4 | 3 | 3 | 4 | 3 |
| | | Example | Example | Comparative | Comparative | Comparative | Comparative | Comparative | Comparative |
| | | 9 | 10 | Example 1 | Example 2 | Example 3 | Example 4 | Example 5 | Example 6 |
| Composition | (A) Wheat albumin | 30 | 40 | 50 | 50 | 80 | 72 | 88 | 55 |
| (% by mass) | (B) Erythritol | 25 | 15 | — | — | 8 | — | — | — |
| | (B) Xylitol | — | 10 | — | — | — | 16 | — | — |
| | Mannitol | — | — | 38 | — | — | — | — | — |
| | Glucose | — | — | — | 38 | — | — | — | — |
| | Lactose | 33 | 23 | — | — | — | — | — | 38 |
| | Crystalline cellulose | 10 | 10 | 10 | 10 | 10 | 10 | 10 | 10 |
| | Calcium stearate | 2 | 2 | 2 | 2 | 2 | 2 | 2 | 2 |
| | Total | 100.0 | 100.0 | 100.0 | 100.0 | 100.0 | 100.0 | 100.0 | 100.0 |
| (a) 0.19-wheat albumin (% by mass) | | 7.5 | 10.0 | 12.5 | 12.5 | 20.0 | 18.0 | 22.0 | 12.5 |
| (B)/(A) | | 0.83 | 0.63 | — | — | 0.10 | 0.22 | — | — |
| (B)/(a) | | 3.33 | 2.50 | — | — | 0.40 | 0.89 | — | — |
| Evaluation | Gnawing feeling | 4 | 4 | 2 | 2 | 2 | 3 | 1 | 1 |
| | Light texture | 4 | 3 | 1 | 3 | 1 | 2 | 1 | 1 |

As obvious from Table 1, in the inventive products, compared with the comparative products, the uncomfortable texture due to wheat albumin was improved, the gnawing feeling was good, and light texture was provided.

### Preparation of Chewable Tablet

### Examples 11 to 22

Chewable tablets were prepared as in Example 1 except that raw material components were mixed based on the blending compositions shown in Table 2. The contents of 0.19-wheat albumin (a) in the chewable tablets are shown in Table 2.

The resulting inventive products were subjected to sensory evaluation. The evaluation was performed by three specialized panelists for gnawing feeling during eating and light texture in accordance with the evaluation criteria shown above. In addition, the adhesion in the mouth during eating, the unusual taste characteristic to wheat albumin, the texture of bubbles, and balance in taste and flavor were evaluated in accordance with the evaluation criteria shown below. In every evaluation, average values were used as marks. The results are shown in Table 2.

### Adhesion in the Mouth

4: adhesion to teeth or tongue is very weak

3: adhesion to teeth or tongue is weak

2: adhesion to teeth or tongue is strong

1: adhesion to teeth or tongue is very strong

### Unusual Taste Characteristic to Wheat Albumin

4: no unusual taste is sensed

3: unusual taste is hardly sensed

2: unusual taste is strongly sensed

1: unusual taste is very strongly sensed

### Texture of Bubbles

4: bubbles in the mouth disappear very fast

3: bubbles in the mouth disappear fast

2: bubbles in the mouth disappear slowly

1: bubbles in the mouth disappear very slowly

### Balance in Taste and Flavor

4: balance without prominent taste and flavor of organic acid and carbonate is very good

3: balance without prominent taste and flavor of organic acid and carbonate is good

2: balance without prominent taste and flavor of organic acid and carbonate is bad

1: balance without prominent taste and flavor of organic acid and carbonate is very bad

TABLE 2

| | | Example 11 | Example 12 | Example 13 | Example 14 | Example 15 | Example 16 |
|---|---|---|---|---|---|---|---|
| Composition | (A) Wheat albumin | 42 | 42 | 42 | 42 | 42 | 42 |
| (% by mass) | (B) Erythritol | 20 | 20 | 20 | 20 | 20 | 20 |
| | (C) Sodium hydrogen carbonate | — | 12 | 10 | 10 | 10 | 13 |
| | (D) Citric acid | — | 14 | 10 | 8 | 6.5 | 8 |
| | Lactose | 26 | — | 6 | 8 | 9.5 | 5 |
| | Crystalline cellulose | 10 | 10 | 10 | 10 | 10 | 10 |
| | Calcium stearate | 2 | 2 | 2 | 2 | 2 | 2 |
| | Total | 100.0 | 100.0 | 100.0 | 100.0 | 100.0 | 100.0 |
| (a) 0.19-wheat albumin (% by mass) | | 10.5 | 10.5 | 10.5 | 10.5 | 10.5 | 10.5 |
| (B)/(A) | | 0.48 | 0.48 | 0.48 | 0.48 | 0.48 | 0.48 |
| (B)/(a) | | 1.90 | 1.90 | 1.90 | 1.90 | 1.90 | 1.90 |
| (A)/(C) mass ratio | | — | 3.50 | 4.20 | 4.20 | 4.20 | 3.23 |
| (a)/(C) mass ratio | | — | 0.88 | 1.05 | 1.05 | 1.05 | 0.81 |
| Equivalent ratio of (D)/(C) | | — | 1.53 | 1.31 | 1.05 | 0.85 | 0.81 |
| Evaluation | Gnawing feeling | 4 | 4 | 4 | 4 | 4 | 4 |
| items | Light texture | 3 | 4 | 4 | 4 | 4 | 4 |
| | Adhesion in the mouth | 2 | 4 | 4 | 4 | 4 | 4 |
| | Characteristic unusual | 1 | 4 | 4 | 4 | 4 | 4 |
| | taste of wheat albumin | | | | | | |
| | Texture of bubbles | — | 4 | 4 | 4 | 4 | 4 |
| | Balance in flavor | 3 | 3 | 3 | 4 | 3 | 3 |
| | | Example 17 | Example 18 | Example 19 | Example 20 | Example 21 | Example 22 |
| Composition | (A) Wheat albumin | 42 | 42 | 42 | 45 | 64 | 30 |
| (% by mass) | (B) Erythritol | 20 | 20 | 20 | 25 | 16 | 25 |
| | (C) Sodium hydrogen carbonate | 8 | 15 | 3.5 | 4 | 4 | 4 |
| | (D) Citric acid | 8 | 11 | 3 | 3 | 4 | 4 |
| | Lactose | 10 | 0 | 19.5 | 11 | — | 25 |
| | Crystalline cellulose | 10 | 10 | 10 | 10 | 10 | 10 |
| | Calcium stearate | 2 | 2 | 2 | 2 | 2 | 2 |
| | Total | 100.0 | 100.0 | 100.0 | 100.0 | 100.0 | 100.0 |
| (a) 0.19-wheat albumin (% by mass) | | 10.5 | 10.5 | 10.5 | 11.3 | 16.0 | 7.5 |
| (B)/(A) | | 0.48 | 0.48 | 0.48 | 0.56 | 0.25 | 0.83 |
| (B)/(a) | | 1.90 | 1.90 | 1.90 | 2.22 | 1.00 | 3.33 |
| (A)/(C) mass ratio | | 5.25 | 2.80 | 12.00 | 11.25 | 16.00 | 7.50 |
| (a)/(C) mass ratio | | 1.31 | 0.70 | 3.00 | 2.81 | 4.00 | 1.88 |
| Equivalent ratio of (D)/(C) | | 1.31 | 0.96 | 1.13 | 0.98 | 1.31 | 1.31 |
| Evaluation | Gnawing feeling | 4 | 4 | 4 | 3 | 3 | 4 |
| items | Light texture | 4 | 4 | 3 | 4 | 3 | 4 |
| | Adhesion in the mouth | 3 | 4 | 3 | 3 | 3 | 3 |
| | Characteristic unusual | 3 | 4 | 3 | 4 | 3 | 4 |
| | taste of wheat albumin | | | | | | |
| | Texture of bubbles | 4 | 4 | 3 | 3 | 3 | 3 |
| | Balance in flavor | 3 | 3 | 4 | 4 | 4 | 4 |

As obvious from Table 2, in the products further having a carbonate and an organic acid blended therein in Examples 12 to 22, the stickiness and adhesion in the mouth during eating were suppressed, the unusual taste characteristic to wheat albumin was reduced, the texture of bubbles was good, and the balance in taste and flavor was good.

What is claimed is:

1. A masticatory solid composition comprising the following components (A) and (B):
(A) wheat albumin, and
(B) erythritol, xylitol, or a combination thereof, wherein
a content mass ratio of the component (B) to the component (A) [(B)/(A)] is 0.25 or more.

2. The masticatory solid composition according to claim 1, wherein a content of the wheat albumin (A) in the masticatory solid composition is 10 to 70% by mass.

3. The masticatory solid composition according to claim 1, wherein the wheat albumin (A) comprises 10 to 60% by mass of 0.19-wheat albumin (a).

4. The masticatory solid composition according to claim 1, further comprising a carbonate (C), wherein
the content mass ratio of the wheat albumin (A) to the carbonate (C) [(A)/(C)] in the solid composition is 1.5 to 16.5.

5. The masticatory solid composition according to claim 4, further comprising an organic acid (D), wherein
an equivalent ratio of the organic acid (D) to the carbonate (C) [equivalent (D)/equivalent (C)] is 0.7 to 1.9.

6. The masticatory solid composition according to claim 1, wherein the solid composition is a chewable tablet.

7. A masticatory solid composition comprising the following components (a) and (B):
(a) 0.19-wheat albumin, and
(B) erythritol, xylitol, or a combination thereof, wherein
a content mass ratio of the component (B) to the component (a) [(B)/(a)] is 1 or more.
